(19) United States
(12) Patent Application Publication
(10) Pub. No.: US 2026/0352992 A1
(43) Pub. Date: Nov. 5, 2026

(54) HEADPHONE DEVICE AND A METHOD FOR CONTROLLING EQUALIZATION SETTINGS IN THE HEADPHONE DEVICE

(71) Applicant: Harman International Industries, Incorporated, Stamford, CT (US)

(72) Inventors: Guotao YUAN, Shenzhen (CN); Bin CAI, Shenzhen (CN)

(73) Assignee: Harman International Industries, Incorporated, Stamford, CT (US)

(21) Appl. No.: 19/723,131

(22) Filed: Jun. 29, 2026

Related U.S. Application Data
(63) Continuation of application No. PCT/CN2023/142413, filed on Dec. 27, 2023.

(51) Int. Cl. H04R 1/10; H04R 29/00

(52) U.S. Cl. CPC H04R 1/1041; H04R 1/1016; H04R 1/105; H04R 29/001; H04R 2420/05; H04R 2420/09; H04R 2460/09

(57) ABSTRACT

A headphone device including a host module, at least two earpiece modules, and an equalizer embedded in the host module. The host module is capable of being selectively connected to one of the earpiece modules and identifying the earpiece module connected to the host module such that the headphone device operates in an operating mode corresponding to the connected earpiece module. The earpiece modules detachably connected to the host module. Each earpiece module assigned to a corresponding operating mode of the headphone device. Equalization settings of the equalizer are automatically switched according to the operating mode in operation.

### CROSS-REFERENCE TO RELATED APPLICATIONS

This application is a continuation of International Application No. PCT/CN2023/142413, filed on Dec. 27, 2023. The disclosure of the above application is incorporated herein by reference.

### FIELD

The present disclosure relates to a headphone and a method for controlling equalization settings in the headphone device.

### BACKGROUND

Currently, there are various types of TWS headphones available in the market, such as in-ear TWS headphones and open-ear TWS headphones.

The structure of in-ear TWS headphones includes an earbud portion that extends into the user's ear canal. The eartip including a speaker or other transducer that outputs audio from an audio source, such as a mobile phone, is inserted directly into the ear canal of the user. The relatively sealed internal environment achieved by the close contact between the eartip section and the user's ear canal prevents sound leakage and prevents external noise from entering the ear canal, thus providing better acoustics.

The open-ear TWS headphones are constructed without eartip that intrude into the user's ear canal. This design means that the user will not feel a foreign body sensation from the ear canal, resulting in a more comfortable wearing experience.

However, both types of TWS headphones have their own drawbacks. For example, in the case of in-ear headphones, the tip of the earbud intrudes into the ear canal, which is a foreign body sensation that some users are very uncomfortable with. For the open-ear headphones, there is no closed chamber between the headphones and the user's ear canal, resulting in damage to the sound quality.

It is often difficult to combine user comfort and good sound quality in a singular headphone design. Users may switch to different headphones depending on the specific usage scenario and current needs. This, in turn, brings about problems in terms of price.

As the foregoing illustrates, what is needed is a headphone device which is capable of satisfying the user's needs and application scenarios by means of low cost.

### SUMMARY

The present disclosure relates to a headphone, wherein the headphone device comprises a host module and at least two earpiece modules. The host module comprises a host housing. The two earpiece modules are detachably connected to the host module. The earpiece modules being each assigned to a corresponding operating mode of the headphone device. The host module is capable of being selectively connected to one of the at least two earpiece modules and identifying the earpiece module connected to the host module such that the headphone device operates in an operating mode corresponding to the connected earpiece module.

According to one or more embodiments of the present disclosure, the host module further comprises a control unit arranged in the host housing, the control unit being designed to enable the headphone device to switch between different operating modes.

According to one or more embodiments of the present disclosure, the at least two earpiece modules are respectively capable of sending different control signals to a control unit when connected to the host module, the control unit identifies the connected earpiece module based on the control signals and prompts the headphone device to operate in an operating mode corresponding to the connected earpiece module.

According to one or more embodiments of the present disclosure, the host module comprises a host connection port, the at least two earpiece modules each comprise a respective earpiece connection port, and the host connection port is capable of selectively establishing a signal connection with the earpiece connection port of one of the at least two earpiece modules.

According to one or more embodiments of the present disclosure, the control unit is configured to be capable of detecting a voltage difference at the host connection port, and realizing switching of the headphone device between different operating modes based on the detected voltage difference.

According to one or more embodiments of the present disclosure, an equalizer is embedded in the host module, wherein equalization settings of the equalizer are automatically switched according to the operating mode in operation.

According to one or more embodiments of the present disclosure, the connection of the host connection port with the earpiece connection port is realized by a spring pin connector.

According to one or more embodiments of the present disclosure, the at least two earpiece modules each comprise their respective earpiece housings, wherein the earpiece housings are capable of being detachably connected to the host housing.

According to one or more embodiments of the present disclosure, the earpiece housings of the at least two earpiece modules each have a different geometry.

According to one or more embodiments of the present disclosure, the host module includes a host mounting surface, and the at least two earpiece modules each include an earpiece mounting surface connectable to the host mounting surface.

According to one or more embodiments of the present disclosure, one of the at least two earpiece modules is configured as an in-ear earpiece module.

According to one or more embodiments of the present disclosure, the in-ear earpiece module comprises an eartip port for attaching an eartip that extends into a user's ear canal.

According to one or more embodiments of the present disclosure, one of the at least two earpiece modules is configured as an open-ear earpiece module.

Additionally, the present disclosure relates to a method for operating a headphone device comprising a host module and at least two interchangeable earpiece module, wherein one of the at least two interchangeable earpiece modules is connected to the host module; the connected earpiece module is identified by the host module; the host module prompts the headphone device to operate in an operating mode corresponding to the connected earpiece module.

According to one or more embodiments of the present disclosure, the host module includes an equalizer, equalization settings of the equalizer are automatically switched according to the operating mode in operation when the host module is operated in the operating mode corresponding to the connected earpiece module.

According to one or more embodiments of the present disclosure, one of the at least two interchangeable earpiece modules is an in-ear earpiece module, when the in-ear earpiece module is connected to the host module, the equalization settings applies to the operating mode for the in-ear piece module.

According to one or more embodiments of the present disclosure, one of the at least two interchangeable earpiece modules is an open-ear earpiece module, when the open-ear earpiece module is connected to the host module, the equalization settings applies to the operating mode for the open-ear piece module.

### DRAWINGS

In order that the disclosure may be well understood, there will now be described various forms thereof, given by way of example, reference being made to the accompanying drawings, in which:

FIG. 1 is a schematic view of a headphone device according to one or more embodiments of the present disclosure;

FIG. 2 is another schematic view of a headphone device according to one or more embodiments of the present disclosure;

FIG. 3 is an exploded view of the headphone device of FIG. 1;

FIG. 4 is an exploded view of the headphone device of FIG. 2;

FIG. 5 is an exploded view of a portion of a headphone device according to one or more embodiments of the present disclosure;

FIG. 6 is an exploded view of a portion of a headphone device according to one or more embodiments of the present disclosure;

FIG. 7 is an exploded view of a portion of a headphone device according to one or more embodiments of the present disclosure;

FIG. 8 is a cross-sectional view of the headphone device of FIG. 1;

FIG. 9 is a cross-sectional view of the headphone device of FIG. 2;

FIG. 10 is a block diagram of the operating principle of the headphone device of FIG. 1;

FIG. 11 is a block diagram of the headphone device shown in FIG. 2; and

FIG. 12 is a flow chart illustrating a method for operating a headphone device according to the present disclosure.

### DETAILED DESCRIPTION

The disclosure can be better understood with reference to the flowing drawings and description. The components in the drawings are not necessarily to scale, emphasis instead being placed upon illustrating the principles of the disclosure. Moreover, in the figures, like reference numerals designate corresponding parts throughout the different views.

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, integers, steps, operations, elements, and/or components, but do not preclude the presence or addition of one or more other features, integers, steps, operations, elements, components, and/or groups thereof. As used herein, the term “and/or” and the symbol “/” are meant to include any and all combinations of one or more of the associated listed items. Additionally, while the terms first, second, etc. may be used herein to describe various elements, components, steps or calculations, these elements, components, steps or calculations should not be limited by these terms, rather these terms are only used to distinguish one element, component, step or calculation from another. For example, a first component could be termed a second component, similarly a first calculation could be termed a second calculation; similarly a first step could be termed a second step; all without departing from the scope of this disclosure.

An aspect of the present disclosure relates to a headphone, wherein the headphone device comprises: a host module comprising a host housing; and at least two earpiece modules detachably connected to the host module, the earpiece modules being each assigned to a corresponding operating mode of the headphone device, wherein the host module is capable of being selectively connected to one of the at least two earpiece modules and identifying the earpiece module connected to the host module such that the headphone device operates in an operating mode corresponding to the connected earpiece module.

As compare to the prior art, the headphone device according to the present disclosure provides at least two interchangeably usable earpiece modules for the host module. As a result, users are able to change the appropriate earpiece module according to their preferences and use scenarios. This means that users do not need to purchase more than one entire headphone devices to meet their current needs, thus reducing costs.

According to one or more embodiments of the present disclosure, the host module further comprises a control unit arranged in the host housing, the control unit being configured to enable the headphone device to switch between different operating modes. The earpiece modules are respectively capable of sending different control signals to a control unit when connected to the host module. The control unit identifies the connected earpiece module based on the control signals and prompts the headphone device to operate in an operating mode corresponding to the connected earpiece module.

The control signals received by the control unit are associated with the earpiece module connected to the host module. Different earpiece modules correspond to different operating modes, and the control unit prompts the headphone device to operate in a corresponding operating mode based on identification the earpiece module in the connected state.

According to one or more embodiments of the present disclosure, the host module comprises a host connection port. The at least two earpiece modules each comprise a respective earpiece connection port. The host connection port is capable of selectively establishing a signal connection with the earpiece connection port of one of the earpiece modules. In one form, the control unit is configured to be capable of detecting a voltage difference at the host connection port, and realizing switching of the headphone device between different operating modes based on the detected voltage difference. In one or more embodiments not shown, it may also be contemplated to identify which earpiece module is currently connected to the host module based on other principles.

According to one or more embodiments of the present disclosure, an equalizer is embedded in the host module, wherein equalization settings of the equalizer are automatically switched according to the operating mode in operation.

According to one or more embodiments of the present disclosure, the connection of the host connection port with the earpiece connection port is realized by a spring pin connector. The spring pin connectors facilitates connection of the host module to the earpiece module. Therefore, the connection between the main unit and the handset module can be accomplished by a non-expert operator, making it possible for the end consumer to replace different earpiece modules with a simple detachment and snap-on action without having to considering about how to connect the complex circuits in the host module and in the earpiece module one by one.

According to one or more embodiments of the present disclosure, the at least two earpiece modules each comprise their respective earpiece housings. The earpiece housings are capable of being detachably connected to the host housing. In one form, the disassembly and assembly of the host module with the earpiece module is achieved in a simple and non-destructive manner with the help of the cooperation of the elastic snap-slot.

According to one or more embodiments of the present disclosure, the earpiece housings of the at least two earpiece modules each have a different geometry. In one or more embodiments not shown, however, the earpiece modules may also each have earpiece housings with the same design.

According to one or more embodiments of the present disclosure, the host module comprises a host connection port, the earpiece modules each comprise a respective earpiece connection port, and the host connection port is capable of selectively establishing a signal connection with the earpiece connection port of one of the earpiece modules. The host mounting surface may be constructed integrally with the host housing. In another form, the host mounting surface may be a component constructed independently with respect to the host housing, which together define an inner cavity for containing the electronic components of the host module. The earpiece mounting surface may be constructed integrally with the earpiece housing. In one form, the earpiece mounting surface may be a component constructed independently with respect to the earpiece housing, which together define an inner cavity for containing the electronic components of the earpiece module.

According to one or more embodiments of the present disclosure, one of the earpiece modules is configured as an in-ear earpiece module. In one form, the in-ear earpiece module comprises an eartip port for attaching an eartip that extends into a user's ear canal. Correspondingly, other earpiece modules may be open-ear earpiece modules, semi-in-ear earpiece modules, and the like.

Another aspect of the present disclosure relates to a method for operating a headphone device comprising a host module and at least two interchangeable earpiece modules, wherein one of the at least two interchangeable earpiece modules is connected to the host module, the connected earpiece module is identified by the host module, and the host module prompts the headphone device to operate in an operating mode corresponding to the connected earpiece module.

According to one or more embodiments of the present disclosure, the host module includes an equalizer, equalization settings of the equalizer are automatically switched according to the operating mode in operation when the host module is operated in the operating mode corresponding to the connected earpiece module. The earpiece module is mechanically and electrically coupled with the host module, and a signal communication is realized between them. As previously described, the host module is capable of identifying an earpiece module connected thereto, wherein the connection of different earpiece modules to the host module results in different voltage differences at the host connection port. The control unit detects the voltage differences and identifies the connected earpiece module, thereby prompting the headphone device to in operate in an operating mode corresponding to the connected earpiece module, wherein equalization settings of the equalizer are automatically switched according to the operating mode in operation. This provides automatic switching of the equalization settings when the earpiece module is replaced.

According to one or more embodiments of the present disclosure, one of the at least two interchangeable earpiece modules is an in-ear earpiece module, when the in-ear earpiece module is connected to the host module, the equalization settings applies to the operating mode for the in-ear piece module; and another of the at least two interchangeable earpiece modules is an open-ear earpiece module, when the open-ear earpiece module is connected to the host module, the equalization settings applies to the operating mode for the open-ear piece module.

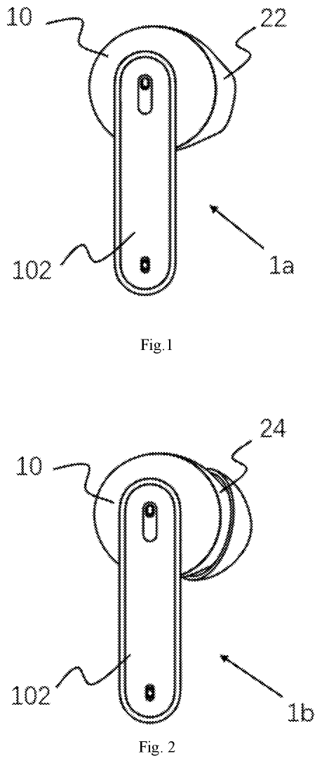

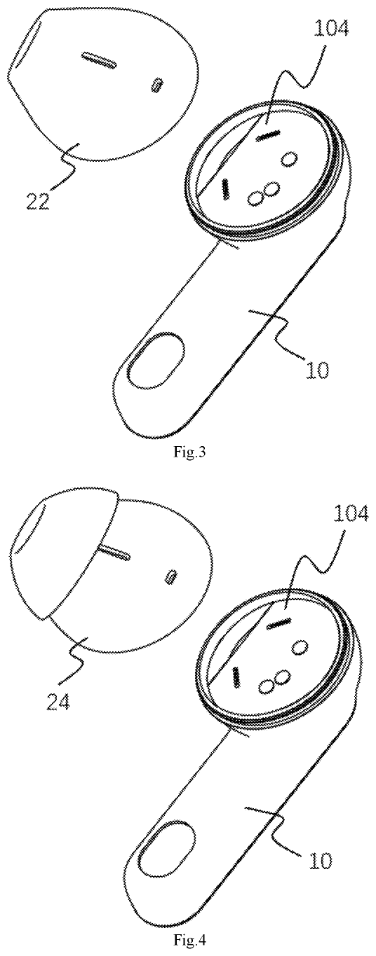

FIGS. 1-4 schematically illustrates a partial three-dimensional view of a headphone device according to the present disclosure. FIG. 1 illustrates an open-ear headphone 1a and FIG. 2 illustrates an in-ear headphone 1b in a combined state. FIGS. 3 and 4 illustrate an open-ear headphone 1a and an in-ear headphone 1b in a detached state, respectively.

A headphone device according to the present disclosure includes a host module 10 and a first earpiece module 22 and a second earpiece module 24 couplable to the host module 10. The open-ear headphone 1a is assembled by coupling of the host module 10 to the first earpiece module 22, while the in-ear headphone 1b is assembled through coupling of the host module 10 to the second earpiece module 24.

The host module 10 includes a host housing 102, wherein the host housing 102 has a rod section and a head section that extends from the rod section and provides a host mounting surface 104 capable of adaptively connecting with different earpiece modules.

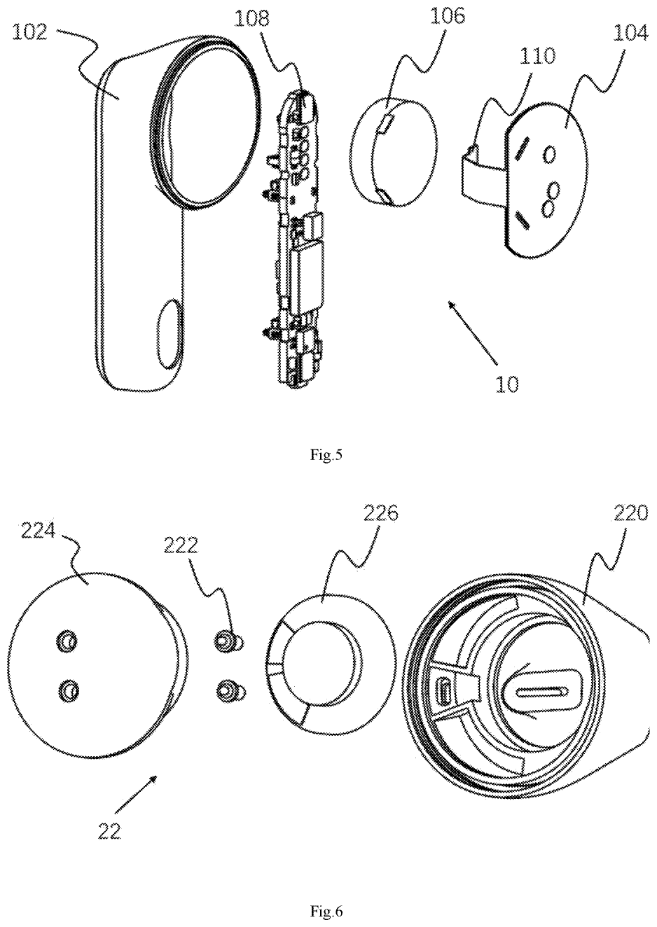

As shown in FIG. 5, a host mounting surface 104 is constituted by a rigid printed circuit board. A cavity is defined between the host mounting surface 104 and the host housing 102, in which a battery 106, a control unit 108 constructed as a main circuit assembly are arranged, wherein an equalizer for adjusting and improving the acoustic characteristics of the headphone device is also embedded in the control unit of the host module. The different equalization settings of the equalizer apply to the different operating modes of the headphone device. In order to connect the rigid printed circuit board with the main circuit assembly, a flexible circuit board 110 is provided on the rigid printed circuit board. In the assembled state of the host module 10, the battery 106 is arranged between the host mounting surface 104 and the main circuit assembly, wherein the flexible circuit board 110 extends past the side of the battery 106 to connect the main circuit assembly with the rigid printed circuit board. In addition, a host connection port is provided on the host mounting surface 104. As shown in FIG. 5, this host connection port has three pin interfaces, i.e., an SPK+ connector, an SPK− connector and an integrated GPIO-ADC connector. The control unit 108 comprises, for example, a Bluetooth-chip that stores varies softwares for different operating modes applicable to the headphone device and is used to receive control signals from the host connection port. The control unit 108 activates different software based on the control signals, so that the headphone device can operate in different operating modes.

FIG. 6 illustrates a first earpiece module 22 for an open-ear headphone comprising a first earpiece housing 220 and a first earpiece mounting surface 224, a first earpiece driver 226 of the first earpiece module 22 is arranged in an inner cavity defined by these two. The first earpiece housing 220 has an external contour that is ergonomically adapted to be embedded within the contour of the user's ear. The first earpiece mounting surface 224 is provided with a plurality of perforations, and the first earpiece connection port 222 is constructed as a spring-pin and protrudes outwardly through the perforations. In this example, the first earpiece connection port 222 includes two spring-pin connectors that are capable of adapting to be connected to the SPK+ connector, SPK− connector of the host connection port.

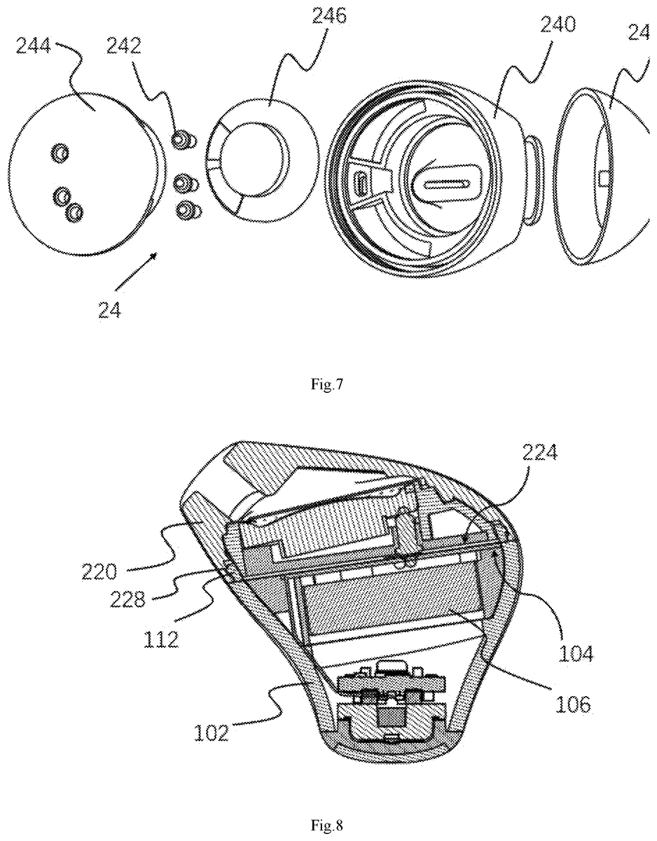

FIG. 7 illustrates a second earpiece module 24 for an in-ear headphone comprising a second earpiece housing 240 and a second earpiece mounting surface 244, a second earpiece driver 246 of the second earpiece module 24 is arranged in an inner cavity defined by these two. The second earpiece housing 240 also has an external contour that is ergonomically adapted to be embedded within the contour of the user's ear. The second earpiece mounting surface 244 is provided with a plurality of perforations, and the second earpiece attachment port 242 is constructed as a spring-pin and protrudes outwardly through the perforations. In this example, the second earpiece connection port 242 includes three spring-pin connectors that are capable of adapting to be connected to the SPK+ connector, SPK− connector and additionally to the GPIO-ADC connector of the host connection port. In addition, an eartip port is also provided on a side of the second earpiece housing 240 opposite the second earpiece mounting surface 244, i.e., on the side facing the user's ear canal, which eartip port is configured as a groove around the open side of the second earpiece housing. An eartip made of an elastomer is embedded in the groove.

With reference to FIGS. 6 and 7, the first earpiece housing 220 and the second earpiece housing 240 have substantially the same geometry, however, in one or more embodiments not shown, the first earpiece housing 220 and the second earpiece housing 240 may also have different geometries depending on the difference in the type of earpiece module.

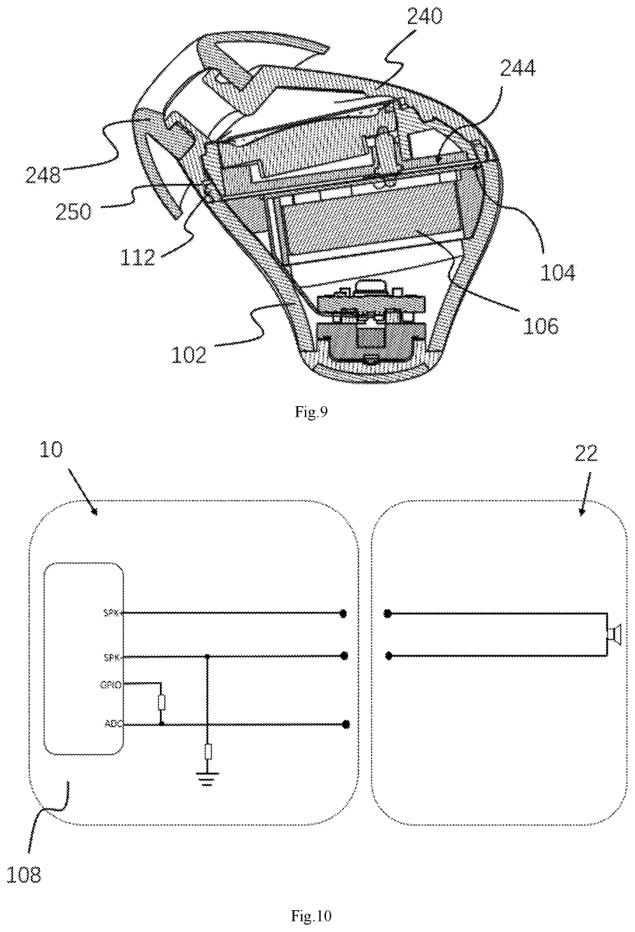

In order to facilitate the connection of the host module to the earpiece module, an outwardly protruding clip 112 is provided at the edges of the host housing surrounding the host mounting surface 104. A corresponding first slot 228 is provided at an edge of the first earpiece housing surrounding the first earpiece mounting surface 224, as shown in FIG. 8. A corresponding second slot 250 is provided at an edge of the second earpiece housing surrounding the second earpiece mounting surface 244, as shown in FIG. 9. The assembly and disassembly of the host module with the first earpiece module or with the second earpiece module can be conveniently achieved through the cooperation of the clip and the slot.

With reference to FIG. 7, the host module 10 is connected to the first earpiece module 22. The host housing 102 and the first earpiece housing 220 are mechanically connected to each other through the snap-fit of the clip 112 and the first slot 228, so that the host mounting surface 104 faces the first earpiece mounting surface 224, wherein the two spring-pin connectors of the first earpiece connection port 222 are adapted to be connected to the SPK+ connector and the SPK− connector, respectively, on the host connection port, as shown in FIG. 10. In this state, the control unit 108 of the host module detects a first voltage difference at the host connection port. For example, in the example shown in FIG. 10, the first voltage difference is 1.8V.

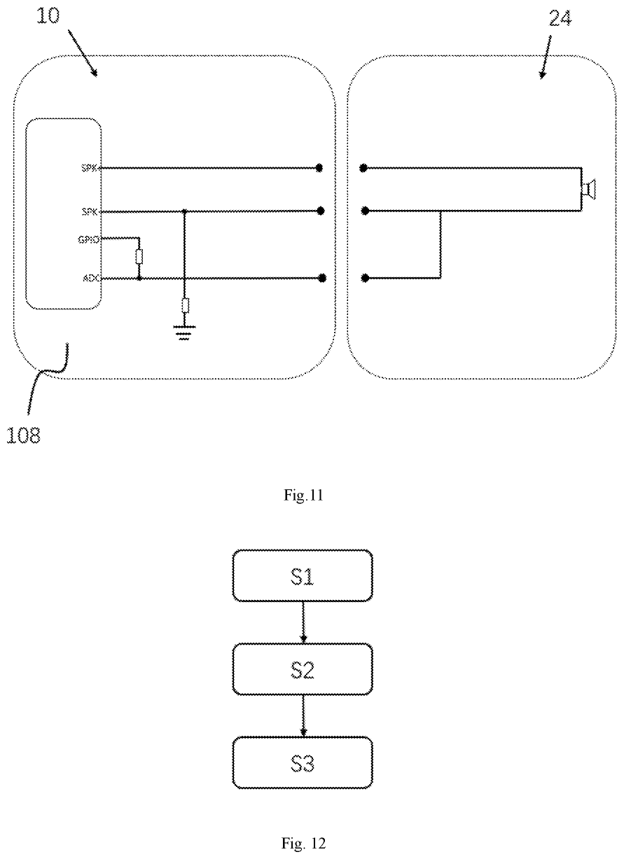

As shown in FIG. 8, the host module 10 is connected to the second earpiece module 24. The host housing 102 and the second earpiece housing 240 are mechanically connected to each other through the snap-fit of the clip 112 and the second slot 250, so that the host mounting surface 104 faces the second earpiece mounting surface 244, wherein the three spring-pin connectors of the second earpiece connection port 242 are adapted to be connected to the SPK+ connector, the SPK− connector and the GPIO-ADC connector, respectively, on the host connection port, as shown in FIG. 11, a pull-down resistor is thereby accessed in the circuit, thereby reducing the voltage difference at the host connection port. In this state, the control unit 108 of the host module detects a second voltage difference at the host connection port. For example, in the embodiment shown in FIG. 11, the second voltage difference is 0.9V.

The connection of the host module 10 to the first earpiece module 22 or to the second earpiece module 24 causes the varies voltage difference at the host connection port detected by the control unit 108. Varies voltage differences result in different control signals, whereby the control unit 108 activates different software to enable the headphone device to operate in different operating modes, wherein different operating modes correspond to different equalization settings of the equalizer. For example, when the first earpiece module 22 is connected to the host module 10, the control unit prompts the headphone device to operate in a first operating mode suitable for the acoustic characteristics of open-ear headphones, wherein the equalization setting of the equalizer is matched to the first earpiece module 22, i.e. the open-ear earpiece module. When the user replaces the first earpiece module 22 with the second earpiece module 24, the control unit then prompts the headphone device to switch to a second operating mode of operation suitable for the acoustic characteristics of in-ear headphones, wherein the equalization setting that matches the first earpiece module is automatically switched to an equalization setting that matches the second earpiece module 24, i.e., the open-ear earpiece module.

In additional, FIG. 12 illustrates a block diagram for operating a headphone device comprises a host module and at least two interchangeable earpiece modules. In one form, the headphone device is constructed as above-mentioned.

The method begins with a first step S1, wherein the one of the at least two interchangeable earpiece modules is connected to the host module. Subsequently, in a step 2 the connected earpiece module is identified by the host module. As above mentioned, the identification of the connected earpiece module could be based on varies voltage difference caused by the connection of different earpiece modules. Then, in step 3 the host module prompts the headphone device to operate in an operating mode corresponding to the connected earpiece module.

In one form, the host module includes an equalizer, in the step 2, equalization settings of the equalizer are automatically switched according to the operating mode in operation when the host module is operated in the operating mode corresponding to the connected earpiece module.

In one form, one of the at least two interchangeable earpiece modules is an in-ear earpiece module, when the in-ear earpiece module is connected to the host module, the equalization settings applies to the operating mode for the in-ear piece module; and another of the at least two interchangeable earpiece modules is an open-ear earpiece module, when the open-ear earpiece module is connected to the host module, the equalization settings applies to the operating mode for the open-ear piece module.

The method can also be applied to headphone devices that have other types of interchangeable earpiece modules, such as semi-in-ear earpiece modules and the like. Correspondingly, the headphone device could be operated in a semi-in-ear operating mode and the equalization settings of the equalizer is automatically switched to apply to the operating mode in operation, i.e. semi-in-ear equalization setting.

The features, structures, or characteristics of one or more embodiments of the present disclosure may be suitably combined.

The present disclosure can be implemented as follows.

Item 1: a headphone, wherein the headphone device comprises: a host module comprising a host housing; and at least two earpiece modules detachably connected to the host module, the earpiece modules being each assigned to a corresponding operating mode of the headphone device, wherein the host module is capable of being selectively connected to one of the at least two earpiece modules and identifying the earpiece module connected to the host module such that the headphone device operates in an operating mode corresponding to the connected earpiece module.

Item 2: the headphone device according to item 1, wherein the host module further comprises a control unit arranged in the host housing, the control unit being designed to enable the headphone device to switch between different operating modes.

Item 3: the headphone device according to item 1 or 2, wherein the at least two earpiece modules are respectively capable of sending different control signals to a control unit when connected to the host module, the control unit identifies the connected earpiece module based on the control signals and prompts the headphone device to operate in an operating mode corresponding to the connected earpiece module.

Item 4: the headphone device according to any of items 1-3, wherein the host module comprises a host connection port, the at least two earpiece modules each comprise a respective earpiece connection port, and the host connection port is capable of selectively establishing a signal connection with the earpiece connection port of one of the at least two earpiece modules.

Item 5: the headphone device according to any of items 1-4, wherein the control unit is designed to be capable of detecting a voltage difference at the host connection port, and realizing switching of the headphone device between different operating modes based on the detected voltage difference.

Item 6: the headphone device according to item 5, wherein an equalizer is embedded in the host module, wherein equalization settings of the equalizer are automatically switched according to the operating mode in operation.

Item 7: the headphone device according to any of items 1-6, wherein the connection of the host connection port with the earpiece connection port is realized by means of a spring pin connector.

Item 8: the headphone device according to any of items 1-7, wherein the at least two earpiece modules each comprise their respective earpiece housings, wherein the earpiece housings are capable of being detachably connected to the host housing.

Item 9: the headphone device according to any of items 1-8, wherein the earpiece housings of the at least two earpiece modules each have a different geometry.

Item 10: the headphone device according to any of items 1-9, wherein the host module includes a host mounting surface, and the at least two earpiece modules each include an earpiece mounting surface connectable to the host mounting surface.

Item 11: the headphone device according to any of items 1-10, wherein one of the at least two earpiece modules is designed as an in-ear earpiece module.

Item 12: the headphone device according to any of items 1-11, wherein the in-ear earpiece module comprises an eartip port for attaching an eartip that extends into a user's ear canal.

Item 13: the headphone device according to any of items 1-12, wherein one of the at least two earpiece modules is designed as an open-ear earpiece module.

Item 14: a method for operating a headphone device comprising a host module and at least two interchangeable earpiece modules, wherein one of the at least two interchangeable earpiece modules is connected to the host module; the connected earpiece module is identified by the host module; the host module prompts the headphone device to operate in an operating mode corresponding to the connected earpiece module.

Item 15: a method according to item 14, wherein the host module includes an equalizer, equalization settings of the equalizer are automatically switched according to the operating mode in operation when the host module is operated in the operating mode corresponding to the connected earpiece module.

Item 16: a method according to item 14 or 15, wherein one of the at least two interchangeable earpiece modules is an in-ear earpiece module, when the in-ear earpiece module is connected to the host module, the equalization settings applies to the operating mode for the in-ear piece module.

Item 17: a method according to any items 14-16, wherein one of the at least two interchangeable earpiece modules is an open-ear earpiece module, when the open-ear earpiece module is connected to the host module, the equalization settings applies to the operating mode for the open-ear piece module.

Systems and methods have been described in general terms as an aid to understanding details of the disclosure. In some instances, well known structures, materials, and/or operations have not been specifically shown or described in detail to avoid obscuring aspects of the disclosure. In other instances, specific details have been given in order to provide a thorough understanding of the disclosure. One skilled in the relevant art will recognize that the disclosure may be embodied in other specific forms, for example to adapt to a particular system or apparatus or situation or material or component, without departing from the spirit or essential characteristics thereof. Therefore, the disclosures and descriptions herein are intended to be illustrative, but not limiting, of the scope of the disclosure. Accordingly, the disclosure is not to be restricted except in light of the attached claims and their equivalents.

What is claimed is:

1. A headphone device comprising:
a host module comprising a host housing; and
at least two earpiece modules detachably connected to the host module, each earpiece module of the at least two earpiece modules being assigned to a corresponding operating mode of the headphone device,
wherein the host module is capable of being selectively connected to one of the at least two earpiece modules and identifying the earpiece module connected to the host module such that the headphone device operates in an operating mode corresponding to the connected earpiece module.

2. The headphone device according to claim 1, wherein the host module further comprises a control unit arranged in the host housing, the control unit being configured to enable the headphone device to switch between different operating modes.

3. The headphone device according to claim 2, wherein the at least two earpiece modules are capable of sending different control signals to the control unit when connected to the host module, the control unit identifies the connected earpiece module of the at least two earpiece modules based on the control signals and prompts the headphone device to operate in an operating mode corresponding to the connected earpiece module.

4. The headphone device according to claim 3, wherein the host module comprises a host connection port, the at least two earpiece modules each comprise a respective earpiece connection port, and the host connection port is capable of selectively establishing a signal connection with the respective earpiece connection port of one of the at least two earpiece modules.

5. The headphone device according to claim 4, wherein the control unit is configured to be capable of detecting a voltage difference at the host connection port, and realizing switching of the headphone device between different operating modes based on the detected voltage difference.

6. The headphone device according to claim 5, further comprising an equalizer is embedded in the host module, wherein equalization settings of the equalizer are automatically switched according to the operating mode in operation.

7. The headphone device according to claim 4, wherein a connection of the host connection port with the respective earpiece connection port is achieved by a spring pin connector.

8. The headphone device according to claim 1, wherein the at least two earpiece modules each comprise respective earpiece housings, and wherein the respective earpiece housings are capable of being detachably connected to the host housing.

9. The headphone device according to claim 8, wherein the respective earpiece housings of the at least two earpiece modules each have a different geometry.

10. The headphone device according to claim 8, wherein the host module includes a host mounting surface, and the at least two earpiece modules each include an earpiece mounting surface connectable to the host mounting surface.

11. The headphone device according to claim 1, wherein one of the at least two earpiece modules is configured as an in-ear earpiece module.

12. The headphone device according to claim 11, wherein the in-ear earpiece module comprises an eartip port for attaching an eartip that extends into a user's ear canal.

13. The headphone device according to claim 1, wherein one of the at least two earpiece modules is configured as an open-ear earpiece module.

14. A method for operating a headphone device comprising a host module and at least two interchangeable earpiece modules, the method comprising
connecting one of the at least two interchangeable earpiece modules to the host module;
identifying the connected earpiece module by the host module; and
prompting, by the host module, the headphone device to operate in an operating mode corresponding to the connected earpiece module.

15. The method according to claim 14, wherein the host module includes an equalizer, equalization settings of the equalizer are automatically switched according to the operating mode in operation when the host module is operated in the operating mode corresponding to the connected earpiece module.

16. The method according to claim 15, wherein one of the at least two interchangeable earpiece modules is an in-ear earpiece module, when the in-ear earpiece module is connected to the host module, the equalization settings apply to the operating mode for the in-ear earpiece module.

17. The method according to claim 15, wherein one of the at least two interchangeable earpiece modules is an open-ear earpiece module, when the open-ear earpiece module is connected to the host module, the equalization settings apply to the operating mode for the open-ear earpiece module.
